(19) United States
(12) Patent Application Publication
(10) Pub. No.: US 2012/0224912 A1
(43) Pub. Date: Sep. 6, 2012

(54) LOOSENING PROTECTION MEANS AND PLUG CONNECTOR HAVING SUCH A LOOSENING PROTECTION MEANS

(75) Inventors: Udo Hoppe, Blomberg (DE); Jens Gerullis, Lemgo (DE)

(73) Assignee: Phoenix Contact GmbH & Co., KG, Blomberg (DE)

(21) Appl. No.: 13/410,208

(22) Filed: Mar. 1, 2012

(30) Foreign Application Priority Data
Mar. 3, 2011 (DE) 10 2011 001 080.7

(51) Int. Cl. F16B 41/00

(52) U.S. Cl. 403/23

(57) ABSTRACT

The subject matter of the invention is a loosening protection means (10) for arrangement on a union nut (12) of a plug connector, having a sleeve (14) and a collar (16) which is formed on the sleeve (14) and, when in an in-use state, at least partially covers a loosening surface (18) of the union nut (12).

### CROSS-REFERENCE TO RELATED APPLICATIONS

This application claims priority to German Patent Application Number DE 10 2011 001 080.7, titled LÖSESICHERUNG UND STECKVERBINDER MIT EINER DERARTIGEN LÖSESICHERUNG, filed on Mar. 3, 2011, the entire contents of which is hereby incorporated herein by reference.

### BACKGROUND OF THE INVENTION

1. Field of the Invention

The invention relates to a loosening protection means for arrangement on a union nut of a plug connector. The invention also relates to a plug connector having a loosening protection means such as this.

2. Description of the Related Art

Plug connectors are used to connect a cable to an appliance connection or to another cable. For this purpose, the plug connectors normally have a contact support, with the conductors of the cable being connected to contacts, which are arranged in the contact support, in order to make a contact. After the connection of the conductors of the cable to the contacts in the contact support, a union nut is screwed onto the contact support and is tightened with a specific torque. For this purpose, the union nut has a sleeve body with an internal thread, with a loosening surface in the form of a hexagonal disk being arranged on the sleeve body. The union nut is used, inter alia, to seal the contact support against moisture and dirt in the area in which the conductors in the inserted cable make contact with the contacts. Furthermore, the union nut can provide strain relief for the conductors of the cable when contact has been made. The union nut can be attached to and released from the contact support via the loosening surface.

### SUMMARY OF THE INVENTION

The invention is based on the object of providing a solution, which makes it possible to prevent the union nut from being inadvertently released from the contact support.

According to the invention, this object is achieved by the provision of a loosening protection means of the type described in more detail initially, which has a sleeve and a collar, which is formed on the sleeve, with the collar, when in an in-use state, at least partially covering a loosening surface of the union nut.

In the case of a plug connector of the type described in more detail initially, this object is achieved according to the invention in that a loosening protection means having a sleeve and a collar which is joined on the sleeve and, when in an in-use state, at least partially covers a loosening surface of the union nut, is arranged on the union nut of the plug connector.

Expedient refinements and advantageous developments of the invention are specified in the dependent claims.

The loosening protection means according to the invention is used to reliably prevent the union nut from being loosened inadvertently, for example by hand. For this purpose, the loosening protection means is arranged on the outer circumferential surface of the union nut, such that the loosening protection means at least partially surrounds the outer circumferential surface of the union nut. The in-use state is the state in which the loosening protection means is arranged on the union nut. The loosening protection means has a sleeve which, in the in-use state, surrounds the sleeve body of the union nut. A collar is integrally formed on the sleeve, at least partially surrounding the area of the loosening protection means of the union nut when in the in-use state. The collar prevents the loosening surface being operable, in particular for loosening of the union nut, without a tool. The collar is preferably formed integrally with the sleeve. However, it may also be arranged as a separate component on the sleeve. A gap is preferably formed between the collar, to be precise the inner surface of the collar, and the loosening surface, via which gap the loosening surface can be operated by a tool, such as an open-ended wrench or a socket wrench. In contrast, the sleeve of the loosening protection means is arranged as close as possible to the outer surface of the sleeve body of the union nut, in order to minimize the requirement for additional physical space for the loosening protection means. The loosening protection means is preferably already arranged on the union nut when the union nut is arranged on the contact support. The loosening protection means according to the invention therefore makes it possible to prevent a union nut from being inadvertently released from a contact support, in a simple and cost-effective manner. If the loosening protection means is already arranged on the union nut when the union nut is arranged on the contact support, the union nut can also be attached to the contact support only by means of an appropriate tool.

According to one preferred refinement of the invention, the loosening protection means can be arranged on the union nut such that it can rotate freely relative to the union nut. This capability of the loosening protection means to rotate freely about the center axis of the loosening protection means in a state in which it is attached to the union nut, that is to say the in-use state, makes it possible to particularly reliably prevent the union nut from being attached or released, in particular being connected by hand.

A latching element is preferably formed on the sleeve, in particular on the inner surface of the sleeve, of the loosening protection means, for captive arrangement of the loosening protection means on the union nut. The latching element may be in the form of a projection, in which case the projection may, for example, be in the form of a hook, a latching tab or a ring, which engages in a recess which is formed on the outer circumferential surface of the union nut. Alternatively, the latching element may, however, also be formed on the inner surface of the sleeve, in the form of a recess, in which a projection, which is formed on the outer circumferential surface of the union nut, engages. In this case, there is preferably play between the projection and the recess, thus making it possible to ensure that the loosening protection means can still rotate freely about its center axis, despite the captive arrangement. In the in-use state in particular, the provision of a latching element prevents the loosening protection means from sliding in the axial direction along the center axis of the union nut, which corresponds to the center axis of the loosening protection means.

According to a further preferred refinement of the invention, the collar is formed from one or more parts. If formed integrally, the collar is formed circumferentially around the loosening surface of the union nut, such that the loosening surface, in particular the longitudinal side surface of the loosening surface, is completely covered by the collar. If the collar is formed integrally, the union nut is attached or loosened by fitting a tool onto the loosening surface from above, that is to say from the end surface of the loosening surface, and operating it. If formed from more than one part, two or more recesses are formed on the collar, such that the loosening surface is not completely covered by the collar along its longitudinal side surface. It is therefore possible to fit a tool on the loosening surface at the side, for attachment and loosening of the union nut.

It is advantageously furthermore possible to provide for a step to be formed between the sleeve and the collar. If a step is provided, the collar, in particular the inner surface of the collar, is radially further away from the center axis of the loosening protection means than the sleeve, in particular the inner surface of the sleeve. The step makes it possible to increase the distance between the loosening surface and the inner surface of the collar, thus making it possible to achieve better accessibility to the loosening surface, for a tool for attachment and loosening of the union nut.

Furthermore, it is preferable for the loosening protection means to be formed from a plastic material. By way of example, polyamide may be used as a plastic material. The use of a plastic material means that the loosening protection means is light in weight and has a good insulating effect. Furthermore, the loosening protection means can be produced at low cost and with little effort, in large quantities.

### BRIEF DESCRIPTION OF THE DRAWINGS

The invention will be explained in more detail in the following text using preferred embodiments and with reference to the attached drawings, in which:

FIG. 1 shows a schematic illustration of a loosening protection means according to the invention, arranged on a union nut, according to a first embodiment;

FIG. 2 shows a schematic illustration of a loosening protection means according to the invention, arranged on a union nut, according to a second embodiment;

FIG. 3 shows a schematic illustration of a loosening protection means according to the invention, arranged on a union nut, according to a third embodiment; and

FIG. 4 shows a schematic section illustration, along a longitudinal side surface of the loosening protection means according to the invention as illustrated in FIG. 2 and arranged on a union nut.

### DETAILED DESCRIPTION OF THE PREFERRED EMBODIMENT

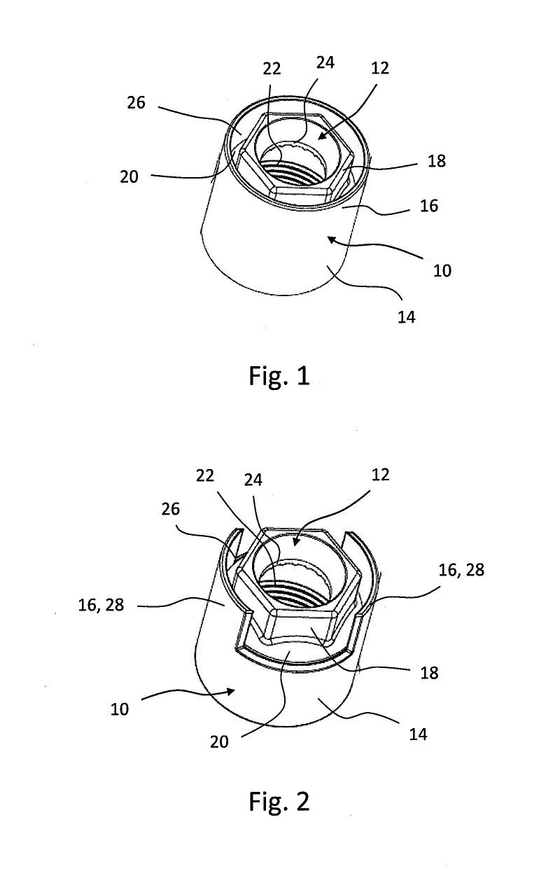

FIG. 1 shows a first embodiment of a loosening protection means 10 which is arranged on a union nut 12 of a plug connector. The loosening protection means 10 has a sleeve 14 and a collar 16, which is formed on the sleeve 14, with the collar 16 completely covering a loosening surface 18, in particular the longitudinal side surfaces of the loosening surface 18, in the in-use state illustrated here. The union nut 12, on a contact support, which is not shown here, of a plug connector, can thus be loosened or attached only by means of a tool and not by hand. The loosening surface 18 is in the form of a hexagonal disk, which is arranged on a cylindrical sleeve body 20 of the union nut 12. As is also shown in FIG. 4, the cylindrical sleeve body 20 has an internal thread 22 for attachment to the contact support, and is at least partially covered by the sleeve 14 of the loosening protection means 10. A splicing ring 24, as is also shown in FIG. 4, is arranged at the junction between the sleeve body 20 and the loosening protection means 18.

In the embodiment shown in FIG. 1, the sleeve 14 and the collar 16 are formed integrally. When formed integrally, the collar 16 is formed circumferentially around the loosening surface 18 of the union nut 12, such that the loosening surface 18, in particular the longitudinal side surface of the loosening surface 18, is completely covered by the collar 16. The union nut 12 is then attached or loosened by fitting a tool onto the loosening surface 18 from above, that is to say from the end surface of the loosening surface 18, and operating it.

The collar 16 is furthermore formed circumferentially, and therefore likewise integrally. A gap 26 is formed between the collar 16, to be precise the inner surface of the collar 16, and the longitudinal side surface of the loosening surface 18, via which gap the loosening surface 18 can be operated by a tool, for example an open-ended wrench or a socket wrench. In contrast, the sleeve 14 of the loosening protection means 10 is arranged as close as possible to the outer surface of the sleeve body 20 of the union nut 12. The collar 16 prevents free accessibility to the loosening surface 18 of the union nut 12 by hand, thus making it possible, in particular, to prevent the union nut 12 from being inadvertently loosened from a contact support by means of the loosening protection means 10.

FIG. 2 shows a second possible embodiment of a loosening protection means 10 according to the invention. The loosening protection means 10 shown in FIG. 2 corresponds essentially to the loosening protection means 10 shown in FIG. 1, but with the collar 16 being formed in two parts, in the embodiment shown in FIG. 2, in contrast to the embodiment shown in FIG. 1, by the collar 16 having two recesses, to be precise two partial elements 28 arranged at a distance from one another, between each of which a recess is provided. Therefore, in the embodiment shown in FIG. 2, the loosening surface 18 is not completely covered by the collar 16 along its longitudinal side surface, thus allowing a tool to also be fitted at the side to the loosening surface 18, for attachment and loosening of the union nut 12.

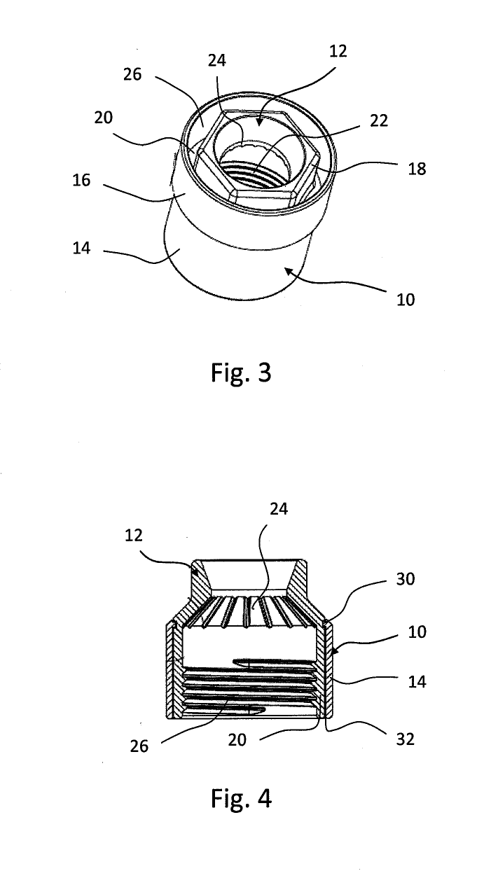

FIG. 3 shows a third possible embodiment of a loosening protection means according to the invention, in which the collar 16, as in the case of the first embodiment shown in FIG. 1, is formed integrally, that is to say it is formed circumferentially around the loosening surface 18 of the union nut 12, and a step is formed between the sleeve 14 and the collar 16. When a step is formed, the collar 16, to be precise the inner surface of the collar 16, is radially further away from the center axis of the loosening protection means 10 than the sleeve 14, to be precise the inner surface of the sleeve 14. The step increases the distance between the loosening surface 18 and the inner surface of the collar 16, and therefore increases the gap 26 between the collar 16 and the loosening surface 18, thus achieving better accessibility to the loosening surface 18 for a tool for attachment and loosening of the union nut 12.

FIG. 4 shows a longitudinal section through a loosening protection means 10 arranged on a union nut 12. As can be seen in this case, the loosening protection means 10 is arranged on and attached to the outer circumferential surface of the union nut 12 in a captive manner, via a latching element 30. In the embodiment shown in FIG. 4, the latching element 30 is in the form of a projection, which is integrally formed on the inner surface of the loosening protection means 10, in particular on the inner surface of the sleeve 14. The latching element 30 engages in a recess, which is formed on the outer circumferential surface of the union nut 12, in order to form a latch. The latching element 30 may be formed integrally with the loosening protection means 10 or may be in the form of a separate component. The fit between the latching element 30 and the recess has play, and a small gap 32 is formed between the inner surface of the sleeve 14 and the outer circumferential surface of the union nut 12, to be precise the outer circumferential surface of the sleeve body 20 of the union nut 12, thus making it possible to ensure that the loosening protection means 10 can rotate freely around the union nut 12, to be precise around the center axis of the loosening protection means 10 and around the center axis of the union nut 12, despite the captive attachment of the loosening protection means 10 to the union nut 12.

### LIST OF REFERENCE SYMBOLS

| | |
|---|---|
| Loosening protection means | 10 |
| Union nut | 12 |
| Sleeve | 14 |
| Collar | 16 |
| Loosening surface | 18 |
| Sleeve body | 20 |
| Internal thread | 22 |
| Splicing ring | 24 |
| Gap | 26 |
| Partial element | 28 |
| Latching element | 30 |
| Gap | 32 |

What is claimed is:

1. A loosening protection component for arrangement on a union nut of a plug connector, having a sleeve and a collar which is formed on the sleeve and, when in an in-use state, at least partially covers a loosening surface of the union nut.

2. The loosening protection component as claimed in claim 1, wherein the loosening protection component can be arranged on the union nut such that it can rotate freely relative to the union nut.

3. The loosening protection component as claimed in claim 1, wherein a latching element for captive arrangement of the loosening protection component on the union nut is formed on the sleeve.

4. The loosening protection component as claimed in claim 1, wherein the collar is formed from one or more parts.

5. The loosening protection component as claimed in claim 1, wherein a step is formed between the sleeve and the collar.

6. The loosening protection component as claimed in claim 1, wherein the loosening protection component is formed from a plastic material.

7. A plug connector, comprising a union nut and a loosening protection component, which is arranged on the union nut, the loosening protection component having a sleeve and a collar which is formed on the sleeve and, when in an in-use state, at least partially covers a loosening surface of the union nut.

8. A loosening protection means configured to be arranged on a union nut of a plug connector, the loosening protection means comprising:
a sleeve; and
a collar formed on the sleeve;
wherein the loosening protection means at least partially surrounds an outer circumferential surface of the union nut when the loosening protection means is in an in-use state.
